(19) United States
(12) Patent Application Publication
(10) Pub. No.: US 2005/0162865 A1
(43) Pub. Date: Jul. 28, 2005

(54) Surface illumination device and display using the same

(76) Inventors: Akimitsu Tsuda, Takarazuka-shi, Hyogo-ken (JP); Satoru Takahashi, Kobe-shi , Hyogo-ken (JP); Hubertina Petronella Maria Huck, Eindhoven (NL); Kousuke Nasu, Osaka-shi , Osaka-fu (JP)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/511,475

(22) PCT Filed: Apr. 17, 2003
(86) PCT No.: PCT/IB03/01539

(30) Foreign Application Priority Data
Apr. 18, 2002 (JP) 2002 116679

(51) Int. Cl. F21V 5/02

(52) U.S. Cl. 362/609; 362/328; 362/339

(57) ABSTRACT

An object of the invention is to provide a surface illumination device and a display device using it, which can contribute to improvement of display qualities. A surface illumination device 10 comprising a light guide plate 1 for propagating incident light inside itself and reflecting the light at the reflecting prism face 1S to output the light from the light exit face. This further comprises: a polarizing plate 3 provided on the light exit face; and an anti-reflection film 4 provided on the polarizing plate 3. The reflecting prism face 1S extends so that a direction of electric vector's vibration of an s-polarized light component of a reflecting light ray caused by an incident light ray in a predetermined propagation direction is in parallel with a polarization axis of the polarizing plate 3, whereby a light efficiency can be improved.

### BACKGROUND OF THE INVENTION

1. Field of the Invention

The present invention relates to a surface illumination device and a display device using it.

The present invention also relates to a surface illumination device and a display device using it, which comprise a light guide plate and means for introducing light to an end face of this light guide plate, wherein light propagating through the light guide plate is directed to an object placed on the undersurface side of the light guide plate so that the whole oncoming face of the object is irradiated with the light as uniformly as possible.

The present invention also relates to a front light system based on such a surface illumination device and a liquid crystal display device with the front light system, and more particularly to a reflective or transflective liquid crystal display device.

2. Description of the Related Art

A reflective or transflective liquid crystal display device has a liquid crystal cell constructed based on inter-opposed substrates between which a liquid crystal layer is sandwiched, and has a display function of a so-called reflection mode wherein the external light is received from the outside of a display face of the cell, and modulated through the liquid crystal layer in accordance with the image to be displayed, and the resultant modulated light is reflected to display the image. Since this type of device also performs displays in the reflection mode even when the external light is weak, it is provided with a front light that supplies light to be incident upon the liquid crystal cell from the surface on the display side of the liquid crystal cell in the same way as for the external light. This front light includes a light guide plate provided facing the surface of the liquid crystal cell on the display side substantially in parallel and an edge light (side light) section that introduces light into an end face of this light guide plate. The light from the edge light section propagates through the light guide plate, and in the propagation process its propagation direction is changed to a direction toward the underside of the light guide plate facing to the liquid crystal cell, that is, a direction toward the surface of the liquid crystal cell on the display side so that the light is introduced into the liquid crystal cell.

Japanese Patent Laid-Open No.306829/99 (or European Patent Publication No. 0 950 851 A1) discloses an arrangement in which an anti-reflection film is laid on the underside of the light guide plate to prevent unnecessary reflection of light caused by the underside of the light guide plate. This anti-reflection film prevents a situation that the (un-modulated) light, which is outputted from the underside toward the liquid crystal cell and has not yet been modulated in accordance with the image to be displayed, is reflected to go out of the light guide plate and forms part of the displayed image. This makes it possible to suppress debasement of contrast and color reproduction performance.

However, the anti-reflection film does not completely prevent reflection of such un-modulated light toward the outside of the display face and some part of the light that enters the film is still reflected. Therefore, display qualities are scarified to some extent.

Furthermore, such an unnecessary reflecting light component is a useless component that is not used for display operation, so that it is one of factors that substantially reduce an efficiency of utilizing light emitted from a light source. The front light is provided on the front side of the display device, and therefore there is an aspect that it is required to have a more compact and lighter structure. The efficiency of utilizing light of the front light generally depends on the area of the prism formed to reflect light on the light guide plate toward the liquid crystal cell, but there is a limit to increasing proportion of the prism area because of such a miniaturization- and weight reduction-oriented structure, and so it is desired that the efficiency of utilizing light can be improved by other constituent elements.

Furthermore, there is another aspect that especially when used as a display device for a cellular phone or the like which operates with a limited battery capacity, the front light is required to assure low power consumption. Reducing power consumption is possible also by increasing the amount of effective light. That is, the greater the amount of effective light relative to the total amount of light emission is, the less power consumption is required with respect to the necessary amount of effective light.

### SUMMARY OF THE INVENTION

The present invention has been made in view of the above mention and its object is to provide a surface illumination device and a display device using it, which can contribute to improvement of display qualities.

Another object of the invention is to provide a surface illumination device and a display device using it, which can improve an efficiency of utilizing light

A further object of the invention is to provide a surface illumination device and a display device using it, which can contribute to improvements of display qualities and efficiency of utilizing light, as well as reduction of power consumption with satisfactory display operation.

In order to attain the above-mentioned objects, the surface illumination device according to one aspect of the invention is a surface illumination device comprising a light guide plate that has a reflecting prism face and a light exit face opposite to the prism face for propagating incident light inside the plate and reflecting the light at the reflecting prism face to output the light from the light exit face, which further comprises: a polarizing plate provided on the light exit face; and an anti-reflection film provided on the polarizing plate.

In this way, because the light outputted from the light guide plate to an object to be illuminated necessarily enters the anti-reflection film after passing through the polarizing plate, the light incident on the anti-reflection film consists just of a predetermined polarized light component extracted through the polarizing plate. Since the amount of light of this polarized light component is reduced approximately by half, the amount of light reflected at the anti-reflection film is also reduced and the amount of light which is not modulated according to the image and reflected here is reduced, which can contribute to improvements of display qualities and efficiency of utilizing light.

In this aspect, the reflecting prism face preferably extends so that a direction of electric vector's vibration of an s-polarized light component of a reflecting light ray caused by an incident light ray in a predetermined propagation direction is in parallel with a polarization axis of the polarizing plate. This makes it possible to increase the amount of light that passes through the polarizing plate and further improve the efficiency of utilizing light.

Instead of the aspect, it is also possible to provide a surface illumination device comprising a light guide plate that has a reflecting prism face and a light exit face opposite to the prism face for propagating incident light inside the plate and reflecting the light at the reflecting prism face to output the light from the light exit face, which further comprises a polarizing plate provided opposite to the light exit face, the reflecting prism face extending so that a direction of electric vector's vibration of an s-polarized light component of a reflecting light ray caused by an incident light ray in a predetermined propagation direction is in parallel with a polarization axis of the polarizing plate. This leads to peculiar effects without the need for forming the anti-reflection film directly on the polarizing plate.

In the case where the form of extending the reflective prism face is defined, the illumination device preferably further comprises: a side light section comprising a light emission section and a light guide body section for propagating the light emitted by the light emission section to widely introduce it into an end face of the light guide plate; and un-divergence means for reducing a degree of divergence of light incident on an end face of the light guide plate, the un-divergence means including a prism body section arranged to cause the light to be incident on the light guide plate in such a manner that the incident light ray in the predetermined propagation direction comes into the reflecting prism face. This makes it possible to reliably form incident light in the predetermined propagation direction and enhance the advantage of the efficiency of utilizing light.

To attain the above-mentioned objects, another aspect of surface illumination device according to the invention is a surface illumination device comprising: a light guide plate that has a reflecting prism face and a light exit face opposite to the prism face for propagating incident light inside the plate and reflecting the light at the reflecting prism face to output the light from the light exit face; and a side light section for introducing the light into an end face of the light guide plate, characterized in that: the side light section comprises a light emission section and a polarizing section for polarizing the light emitted by the light emission section, and is arranged so that the polarized light component is introduced into an end face of the light guide plate; and the polarizing section has a polarizing axis parallel with a direction of electric vector's vibration of an s-polarized light component of a reflecting light ray caused in the reflecting prism face by an incident light ray in a predetermined propagation direction.

This allows the polarized light component entering the light guide plate from the side light section to propagate through the light guide plate and go out of the light exit face. Since this outgoing light has plenty of component of a vibration direction parallel to the polarization axis of the polarizing plate placed opposite to the light exit face, light is apt to pass through the polarizing plate. Display qualities are also kept at a satisfactory level at the same time.

In this aspect, the side light section may comprise a light guide body section for propagating the light emitted by the light emission section to widely introduce it into an end face of the light guide plate; the surface illumination device may further comprise un-divergence means for causing a degree of divergence of the light incident on an end face of the light guide plate to be reduced; and the un-divergence means may comprise a prism body section arranged to make light to enter the light guide plate in such a manner that the incident light ray in the predetermined propagation direction is introduced into the reflecting prism face. This makes it possible to generate the incident light ray in the predetermined propagation direction more reliably and enhance the advantage of the efficiency of utilizing light.

In the above aspects, the predetermined propagation direction may be a propagation direction in which the incident light ray can make a plane of incidence that is perpendicular to the reflecting prism face and the light exit face, or a plurality of swath-shaped faces may be used for the reflective prism face, and the predetermined propagation direction may be a direction along a plane perpendicular to a longitudinal direction of the swath-shaped face. These are for presenting a technique for accurately determining the predetermined propagation direction.

In the configuration with the un-divergence means, the prism body section may be formed integral with the light guide plate, the prism body section may be formed on the polarizing section, or the prism body section may be formed integral with the light guide body section. Specific effects and advantages can be expected by doing so. When a prism for making un-divergence is formed on the light guide plate in particular, it can be formed simultaneously with the reflective prism face of the light guide plate, which is advantageous in respect of the manufacturing. It also has the merit that once an optimum light guide plate is formed, there will be no need for adjustments for matching the un-divergence prism with the reflective prism face.

The above-described various surface illumination devices can be used as the front light in a display device, wherein the surface illumination device is arranged in such a manner that the light exit face is faced to a display face of the display device. Based on this arrangement, there is provided a form that the display device has a second polarizing plate provided faced to the light exit face, the reflecting prism face extending so that a direction of electric vector vibration of an s-polarized light component of a reflecting light ray caused by an incident light ray in the predetermined propagation direction is also in parallel with a polarization axis of the second polarizing plate. In the other forms, the display device may comprise a liquid crystal cell for performing optical modulation in accordance with an image to be displayed, the polarizing plate being carried on the liquid crystal cell or only a single polarizing plate being provided on the light exit side of the light guide plate.

Furthermore, to attain the above-mentioned objects, the surface illumination device according to a further aspect of the invention is a surface illumination device comprising: a light guide plate that has a reflecting prism face and a light exit face opposite to the prism face for propagating incident light inside the plate and reflecting the light at the reflecting prism face to output the light from the light exit face; and a side light section for making light to be incident on an end face of the light guide plate, wherein the side light section comprises a light emission section, a light guide body section for propagating the light emitted by the light emission section to widely introduce it into an end face of the light guide plate, and un-divergence means for causing a degree of divergence of the light incident on an end face of the light guide plate to be reduced, the un-divergence means comprises a prism body section formed integral with the light guide body section.

This makes it possible to perform un-divergence without the increase of the number of parts as in the past, which is advantageous in manufacturing respects and can contribute to reduction of size and weight of the device.

In this aspect, the light guide body section may have a light exit face faced toward an end face of the light guide plate and a light reflective face opposed to the exit face, the prism body section being formed by projections and depressions of the light exit face. This advantageously makes it possible to form a V-groove, etc., which is formed on the back of the light guide body section to provide optical reflectivity and at the same time to form the prism body section.

### BRIEF DESCRIPTION OF THE DRAWINGS

FIG. 1 is a section view showing a schematic structure of a front light according to one embodiment of the present invention and a reflective liquid crystal display device using it.

FIG. 2 is a schematic plan view of the front light of FIG. 1.

FIG. 3 is a diagrammatic illustration for explaining effects and advantages of the front light of FIG. 1.

FIG. 4 is a plan view showing a schematic structure of a front light with a polarizing plate on a side of the side light, according to another embodiment of the invention.

FIG. 5 is a diagrammatic illustration for explaining effects and advantages of the front light of FIG. 4.

FIG. 6 is a plan view showing a schematic structure of a front light with a light-gathering prism, according to a further embodiment of the invention.

FIG. 7 is a perspective view showing a configuration of the prism used in the front light of FIG. 6.

FIG. 8 is a plan view showing the other form of a front light with a light-gathering prism.

FIG. 9 is a plan view showing a further form of a front light with a light-gathering prism.

### DESCRIPTION OF THE PREFERRED EMBODIMENT(S)

These and other aspects of the invention will be described in more detail below with reference to the attached drawings.

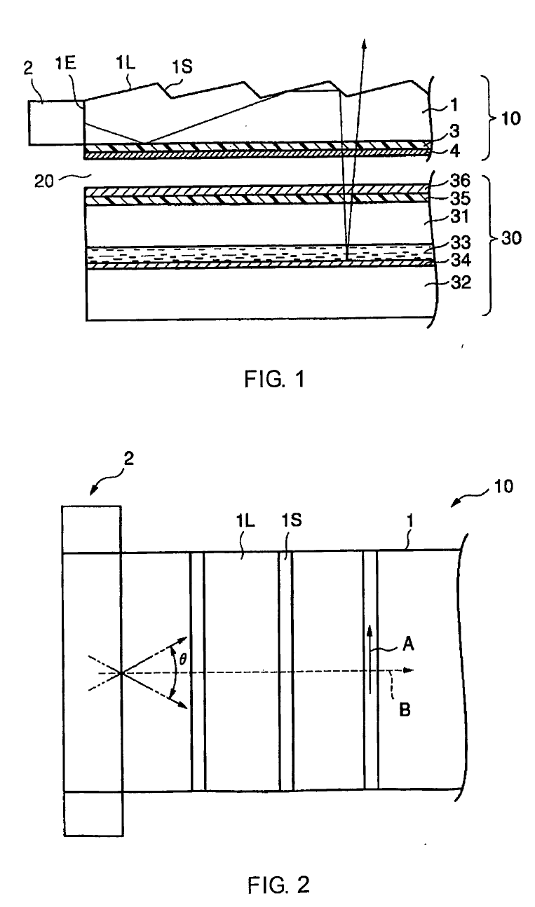

FIG. 1 schematically shows a sectional structure of a front light according to one embodiment of the present invention and a reflective liquid crystal display device using it, and FIG. 2 is a schematic plan view of this front light.

In FIG. 1, a front light 10 has a light guide plate 1 and a side light section 2 placed on an end face 1E side of the front light. The front light 10 of this embodiment also includes a polarizing plate 3 directly bonded to the underside of the light guide plate 1 and an anti-reflection film 4 formed on the polarizing plate 3 in such a manner as to cover the polarizing plate 3.

The light guide plate 1 has a prism surface layer portion with alternating projections and depressions on its upside. This prism surface layer portion is formed, in this example, based on combinations by alternation of a gentle slope 1L having a relatively large area and sloping relatively gently with respect to an extending direction of the light guide plate and a steep slope 1S having a relatively small area and sloping relatively steeply with respect to the same direction.

The light from the side light section 2 enters the end face 1E of the light guide plate 1, and the light guide plate 1 propagates this incident light inside of the plate 1. In this propagation process, the light is reflected at the steep slope (reflective prism face) 1S, changes its propagation direction significantly and goes out of the bottom (light exit face) of the light guide plate 1 toward the polarizing plate 3. The light incident on the polarizing plate 3 now undergoes an effect of polarization, and a predetermined polarized component (s-polarized light) is guided to a liquid crystal cell 30 through the anti-reflection film 4.

The front light 10 is attached to the reflective type liquid crystal cell 30 through an air layer 20. The liquid crystal cell 30 is mainly comprised of two inter-opposed substrates 31, 32, and a liquid crystal layer 33 and an optical reflective layer 34 sandwiched between these substrates. The liquid crystal cell 30 of this embodiment includes a retardation film 35 provided on the upper or the display side transparent substrate 31 and an anti-reflection film 36 formed thereon. FIG. 1 illustrates a configuration of the reflective liquid crystal display cell 30 in quite a simplified form and other elements and configurations are apparent from various publicly known documents, and so their details are omitted herein.

The light that downward goes out of the front light 10 passes through the air layer 20 and enters the liquid crystal cell 30. Then, this light reaches the reflective layer 34 through the anti-reflection film 36, retardation film 35, substrate 31 and liquid crystal layer 33 in this order, and after being reflected from the reflective layer, the light is returned to the air layer 20 through the liquid crystal layer 33, front substrate 31, retardation film 35 and anti-reflection film 36 in inverse order. In this process, the liquid crystal layer 33 modulates the light in accordance with the image to be displayed and the retardation film 35 performs color compensation for light.

The light that goes out of the liquid crystal cell 30 passes through the air layer 20 and enters the front light 10 again. Then, the light passes inside the light guide plate 1 through the anti-reflection layer 4 and polarizing plate 3, and penetrates the prism surface layer portion to propagate to the outside.

In the front light 10 in such a configuration, instead of an anti-reflection film formed directly on the bottom of the light guide plate 1, the anti-reflection film 4 is formed via the polarizing plate 3 indirectly on the bottom. This makes the downward light that has left the light guide plate 1 inevitably enter the anti-reflection film 4 after passing through the polarizing plate 3 first. Thus, it is only a predetermined polarized light component (approximately half the total amount of output light of the light guide plate 1) which has been extracted by the polarizing plate that enters the anti-reflection film 4 from the light guide plate 1. Therefore, only the light with that reduced amount of light is allowed to enter the anti-reflection film 4, and thereby the amount of light reflected therefrom also decreases and the aforementioned unnecessary reflected light is reduced, whereby not only improvement of display qualities but also contribution to improvement of the efficiency of utilizing light is achieved.

Furthermore, in this embodiment, the polarizing plate 3 serves as a polarizing plate which is to be originally used in a liquid crystal cell. That is, the polarizing plate 3 exerts an effect of polarization for causing the outgoing light to have a polarized state required for light to be incident on the liquid crystal cell 30. Therefore, though the amount of light is reduced by the polarizing plate 3 of the front light 10, the polarizing plate 3 carries out polarization just on an earlier stage and does not affect the original mechanism to form images in the liquid crystal cell. Likewise, the polarizing plate 3 provided on this front light can also bring about polarization for the external light with preventing reflection at the anti-reflection film 4. Thus, increase in the number of constituent elements necessary for the overall liquid crystal display device is circumvented.

This embodiment further achieves desirable results by defining relationship between the reflecting prism face 1S and the polarizing plate 3 as follows.

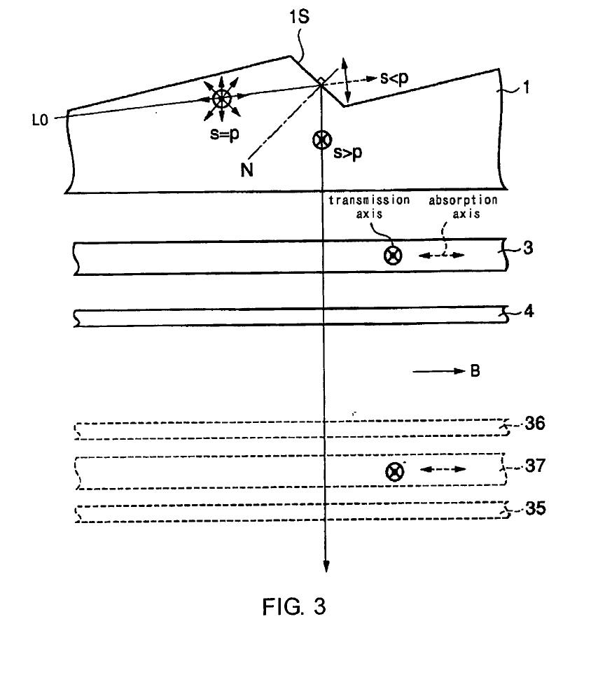

FIG. 3 schematically illustrates a state of light propagating through the front light 10 in order to describe such a definition in more detail, which is a cross-section view of the light guide plate 1 taken along a direction perpendicular to a longitudinal direction of the swath-shaped reflecting prism face 1S.

In FIG. 3, light L0 that propagates inside the light guide plate 1 enters the reflecting prism face 1S without being polarized at all here. It is possible to assume that the light L0 has its s-polarized light and p-polarized light of the same amount of light. At the reflecting prism face 1S, part of this incident light L0 is reflected and the rest of the incident light L0 passes through the reflective prism face 1. However, the amount of s-polarized light is greater than the amount of p-polarized light for the reflected light, while the amount of p-polarized light is greater than the amount of s-polarized light for the transmitted light. This is because the incident light is all reflected within a range of angles of incidence equal to or greater than a critical angle (approximately 420 when the light guide plate 1 is of PMMA (polymethyl methacrylate) as it is, whereas the reflectance of the s-polarized light component is generally greater than the reflectance of the p-polarized light component (the transmittance of the p-polarized light component is greater than the transmittance of the s-polarized light component) within a range of angles of incidence less than the critical angle.

Thus, the reflecting prism face 1S reflects more s-polarized light. If a direction of electric vector's vibration of the reflecting light at this time (in FIG. 3, a direction perpendicular to the drawing sheet, which is indicated with the corresponding mark) is parallel to a transmission axis of the polarizing plate 3, the s-polarized light can pass through the polarizing plate 3 without any loss as is.

On the other hand, the direction of electric vector's vibration of the s-polarized light of the reflecting light is determined by a three-dimensional direction in which in which the reflecting prism face 1S is inclined at the point of incidence and a propagation (progress) direction of the incident light L0. This is because the reflecting light is in a plane of incidence including the incident normal N determined by the inclination direction of the face 1S and an incident light ray.

In view of these respects, the reflecting prism face 1S according to the embodiment is formed to have such inclination that the direction of electric vector's vibration of the s-polarized light of the reflecting light caused by the incident light ray in a predetermined propagation direction is in parallel with a direction of the polarization axis of the polarizing plate 3 (in FIG. 3, a direction perpendicular to the drawing sheet, which is indicated with the corresponding mark). This allows s-polarized light capable of passing through the polarizing plate 3 to be output from the light guide plate 1 in a higher degree, which improves the efficiency of utilizing light.

The predetermined propagation direction according to the embodiment is a propagation direction of an incident light ray capable of forming a plane of incidence perpendicular to the reflecting prism face 1S and perpendicular to the light exit face of the light guide plate (or the main light-receiving plane (including a virtual primary surface) on the liquid crystal cell side). In the case where the reflecting prism faces 1S are shaped into a plurality of swath-shaped faces extending across the display area as in this example, the predetermined propagation direction may be a direction defined within a plane perpendicular to a long side of the swath-shaped face, that is, its longitudinal direction. This predetermined propagation direction is indicated in FIG. 2, which corresponds to a direction B perpendicular to the longitudinal (extending) direction A. The light that actually enters the light guide plate has a distribution of values (e.g., values worth peaks) equal to or greater than a predetermined intensity within a certain extent of angle range θ (see FIG. 2) relative to this predetermined propagation direction. This angle range θ is preferably set to within 30° and more preferably set to within 20°.

Although we have described so far that the polarizing plate to be provided on the liquid crystal cell 30 is provided on the front light 10 as the polarizing plate 3, it is also possible to provide the original polarizing plate on the liquid crystal cell 30 together with the polarizing plate 3 of the front light. For example, it is possible to place that polarizing plate (polarizing plate 37 depicted by a dotted line in FIG. 3) between the retardation film 35 and the anti-reflection film 36. In this case again, from the standpoint of the optical efficiency, the direction of electric vector's vibration of the s-polarized light of the reflecting light ray caused by the incident light ray in the predetermined propagation direction, described above, is preferably set in parallel with a polarization axis of the second polarizing plate 37.

Furthermore, it is originally preferable to perform the above-described optimization for the inclination direction of the reflecting prism face 1S of the light guide plate and the polarization axis of the polarizing plate placed opposite to the light exit face, irrespective of the location of the polarizing plate and irrespective of the presence/absence of the anti-reflection film. Therefore, it is not excluded that the optimization is carried out for the constitutions having the polarizing plate placed between the light guide plate and the liquid crystal cell (including a constitution in which the liquid crystal cell carries a single polarizing plate).

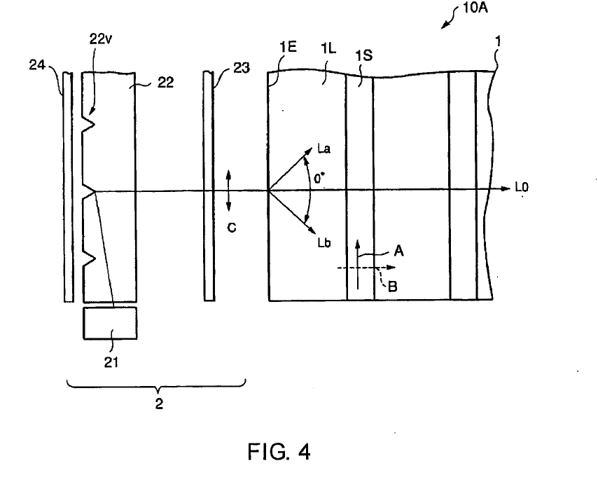

FIG. 4 is a plan view showing a schematic structure of the front light according to another embodiment of the invention.

In FIG. 4, a side light section 2 for introducing light into an end face 1E of a light guide plate 1 is provided faced to the end face 1E. The side light section 2 comprises a light emission section 21, here comprised of an LED, a light guide body section 22 called a “light stick” or “light pipe” for propagating the light emitted by the light emission section to widely introduce it into the end face 1E or preferably over the entire area thereof and a polarizing plate 23 for polarizing the propagation light before introducing the light into the end face 1E. The light guide body section 22 has the rear on which grooves as a structural section for reflecting the propagation light, for example, V-grooves 22v are formed, and further a reflector 24 for assuring the reflection action is provided outside the light guide body section 22.

The light emitted by the light emission section 21 propagates inside the light guide body section 22, and in this process the propagation direction of the light is changed toward the end face 1E by the V-grooves 22v and reflector 24. Then the light goes out of the light guide body section 22 and reaches the polarizing plate 23, and only a predetermined polarized light component is allowed to pass therethrough. The polarized light from the polarizing plate 23 enters the light guide plate 1 from its end face 1E.

The underside of the light guide plate 1 may be constructed with the polarizing plate 3 and anti-reflection film 4 shown in FIG. 1 or may also be constructed in such a manner that the liquid crystal cell carries a necessary polarizing plate (for external light) and only the anti-reflection film 4 is formed on the light guide plate 1 or no anti-reflection film is formed on the light guide plate 1.

In the front light 10A of such constitutions, the light that enters the light guide plate 1 from the side light section 2 becomes a polarized light component passing through the polarizing plate 23. This polarized light component propagates through the light guide plate 1 and goes out of a bottom face of the light guide plate. When the polarizing axis of the polarizing plate 23 is set in a desired manner, it is possible to allow this outgoing light to carry much component in a direction of the vibration which is parallel to the polarizing axis of the polarizing plate 3 or 37 placed opposite to the bottom face.

Especially, desirable results are obtained by defining a relationship between the reflecting prism face 1S and the polarizing plate 23 as follows.

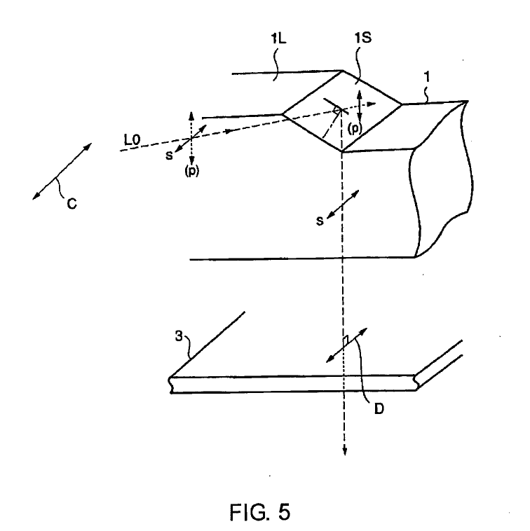

FIG. 5 schematically shows how light propagates through the front light 10A in order to describe such a definition more specifically.

In FIG. 5, light L0 propagating inside the light guide plate 1 has been polarized by the polarizing plate 23, and therefore it enters the reflecting prism face 1S while vibrating about a predetermined direction. If the polarizing axis of the polarizing plate 23 is an axis C as shown in FIG. 5, it is basically assumed that light of vibration direction parallel to the axis C enters the reflecting prism face 1S.

Here, the light L0 is preferably parallel to the vibration direction of the s-polarized light reflected at the reflecting prism face 1S. This is because the reflecting light ray reflects a larger quantity of the s-polarized light in an area below a critical angle. In an extreme case where a p-polarized light ray in the vibration direction expressed by a dotted line (p) of FIG. 5 enters the reflecting prism face 1S, the amount of light reflected at the reflecting prism face 1S is small and the amount of transmitted light large, disadvantageously. Upon reconsidering the matter, if desired s-polarized light enters the reflecting prism face 1S, the amount of light reflected at the reflecting prism face 1S will be increased.

However, since the vibration direction of the s-polarized light of the reflecting light ray is determined by the three-dimensional inclination direction at the point of incidence of the reflective prism face and the propagation (traveling) direction of the incident light L0, the vibration direction of the s-polarized light cannot be specified even if the inclination direction of the reflecting prism face 1S is determined unless the propagation direction of the incident light L0 is limited to a certain extent.

In view of these circumstances, the polarizing plate 23 according to the embodiment is intended to have the polarizing axis (C) parallel to a direction of electric vector's vibration of the s-polarized light of the reflecting light ray presented on the reflecting prism face 1S caused by the incident light L0 in the predetermined propagation direction. This allows a larger quantity of s-polarized light capable of passing through the polarizing plates 3, 37 (their polarization axis is expressed by a reference character D in FIG. 5) located facing the bottom face of the light guide plate 1, to be outputted from the light guide plate 1, which improves the efficiency of utilizing light.

As described above, the predetermined propagation direction in this example is also set to a propagation direction of an incident light ray capable of forming a plane of incidence perpendicular to the reflecting prism face 1S and perpendicular to the light exit face of the light guide plate (or the main light-receiving plane on the liquid crystal cell side). In the case where the reflecting prism face 1S takes the form of swath extending across the display area as shown in FIG. 4, the predetermined propagation direction is a direction B which is perpendicular to its longitudinal (extending) direction A. The angle range θ that the incident light actually has is the same as described above.

Within the confines of incident light rays that form the above-described plane of incidence, any incident light rays have only a component vibrational in parallel to the desired vibration direction of s-polarized light. On the contrary, the light (La, Lb, etc.) that propagates deviated from the crossing direction B as shown in FIG. 4 can not form such a plane of incidence and the s-polarized light that goes out of the light guide plate I does not nave the desired vibration component.

There have been mentioned above, the configuration with a polarizing plate provided on the bottom side of the light guide plate and the configuration with a polarizing plate provided on the side light section. One of features of either configuration is that the polarization axis of the polarizing plate used is matched with the inclination direction of the reflective prism face based on the propagation direction of the light incident on the reflecting prism face 1S of the light guide plate. Therefore, confining the propagation directions of the light within a certain range, or more preferably, allowing light in the predetermined propagation direction to mainly propagate through the light guide plate will lead to more enhanced and reliable effects of the matching.

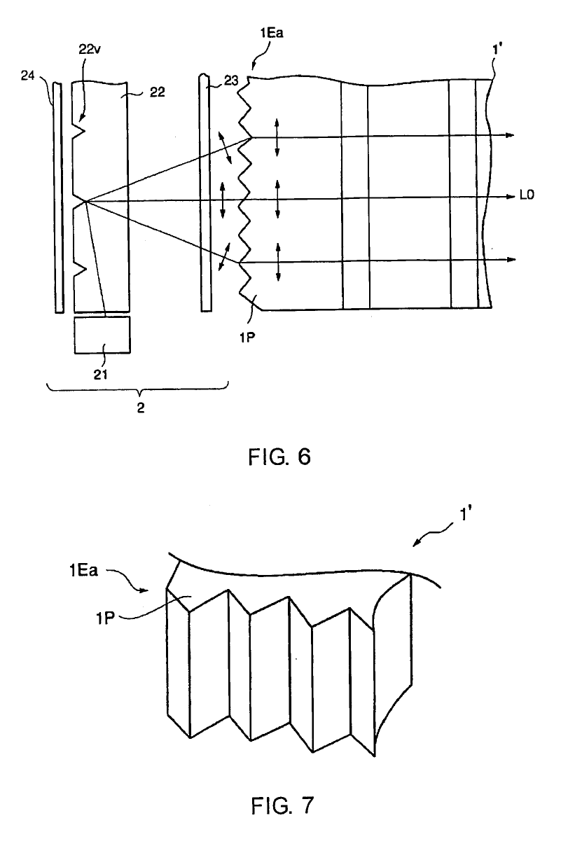

FIG. 6 shows an embodiment for that purpose and parts equivalent to those in FIG. 4 are assigned the same reference symbols.

In FIG. 6, a light-collecting prism 1P is formed integrally with a light guide plate 1 on an end face 1Ea of the light guide plate 1. This light-collecting prism 1P plays the role of un-divergence means for reducing the degree of divergence of light that enters the light guide plate 1 or more preferably converting it to parallel light rays, and is configured so as to introduce light into the light guide plate 1 so that the incident light in the above-described predetermined propagation direction can enter the reflecting prism face 1S.

More specifically, the light-collecting prism 1P has projections and depressions as shown in FIG. 7. That is, projections (or depressions) each consisting of a pair of flat slopes 1m, 1n are continuously formed in the long side direction of the rectangle, which is an outline shape of the end face section of the light guide plate 1′. The peak lines of these projections extend in a direction perpendicular to the long side direction. The cycle of peak lines, the angles of the peaks and a regularity of projections and depressions are set appropriately.

The prism 1P brings even the light rays outputted with directivities from the polarizing plate 23 into a parallelism with each other as shown in FIG. 6, whereby it is assured that an incident light ray capable of forming a plane of incidence perpendicular to the reflecting prism face 1S and perpendicular to the light exit face of the light guide plate 1 as described above enter the reflecting prism face 1S.

By the way, the effects of converting divergent light to light rays that propagates in parallel is, per se, known from Japanese Patent Application Laid-Open No.231320/99 etc., and therefore details thereof will not be given any more.

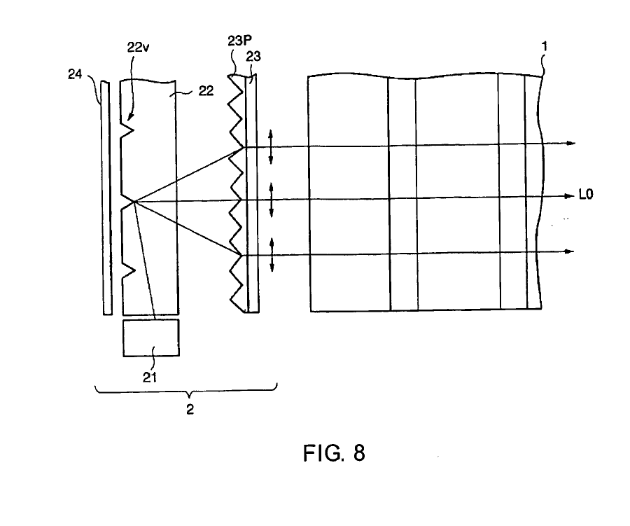

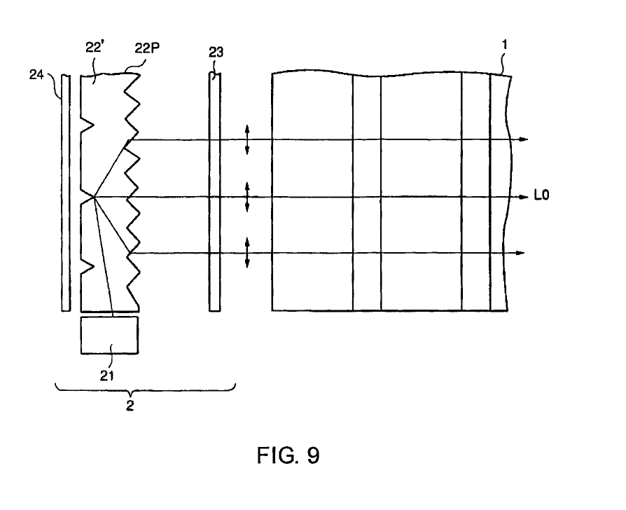

It is also possible to provide a similar prism at other locations. FIG. 8 shows an example where the prism is formed on the polarizing plate 23, and FIG. 9 shows an example where the prism is formed on the light guide body section 22.

FIGS. 6, 8 and 9 show examples of providing an un-divergence prism in a configuration having a side light section with a polarizing plate, but it is also possible to provide an un-divergence prism in a configuration having a polarizing plate on the underside of the light guide plate whereby similar effects can be expected.

When the prism 1P is formed on the end face of the light guide plate 1′ as shown in FIG. 6, the light guide plate alone can advantageously optimize the inclination direction of the reflecting prism face 1S and an un-divergence effect of the prism 1P simultaneously.

When the prism 23P is formed on the polarizing plate 23 as shown in FIG. 8, it is possible to simply bring an easily available prism sheet into application. That is, this has an advantage that the prism 23P can be easily pasted onto a flat surface of the polarizing plate 23.

When the prism 22P is formed on a light stick 22′ made up of a transparent light guide body as shown in FIG. 9, this has an advantage that the prism 22P can be formed simultaneously with the reflection V-grooves 22v on the back of the light stick, which is convenient for manufacturing.

The un-divergence prisms in FIGS. 6, 8 and 9 can offer the following advantages specific to the prisms without the presence of the polarizing plate 23.

Even if the converted light having been in parallel rays by the un-divergence prism is introduced into the light guide plate without being polarized, the reflecting prism face 1S allows the converted light to be easily reflected in the in-plane direction perpendicular to the light exit face of the light guide plate (or main light-receiving plane of the liquid crystal cell). In other words, it is possible to allow the light guide plate to introduce the light into the liquid crystal cell with a narrow directivity. This allows the liquid crystal cell to reflect light with the similar narrow directivity, making it possible to obtain a brighter image.

The above-described embodiments have been explained about a reflective liquid crystal display device, but the present invention is also applicable to a transflective liquid crystal display device.

Furthermore, the reflecting prism face 1S has a swath-shaped plane having a long side along the direction perpendicular to the normal on the main light-receiving plane of the light guide plate, but the present invention is not limited to this from. For example, the reflecting prism face 1S may also be set along a direction deviated from the direction perpendicular to the normal by a predetermined angle or may also have any shape other than a swath-shape.

### EXPLANATION OF SYMBOLS

10 . . . front light
1 . . . light guide plate
1S . . . reflecting prism face
1P, 22P, 23P . . . prism section for making un-divergence
2 . . . side light section
21 . . . light emission section
22 . . . light stick
22v . . . V-groove for light reflection
23 . . . polarizing plate
24 . . . reflector
3 . . . polarizing plate
4 . . . anti-reflection film
30 . . . liquid crystal cell
31, 32 . . . substrate
33 . . . liquid crystal layer
34 . . . reflective layer
35 . . . retardation film
36 . . . anti-reflection film

1. A surface illumination device comprising a light guide plate that has a reflecting prism face and a light exit face opposite to the prism face for propagating incident light inside the plate and reflecting the light at the reflecting prism face to output the light from the light exit face, which further comprises:
a polarizing plate provided on the light exit face; and
an anti-reflection film provided on the polarizing plate.

2. A surface illumination device as defined in claim 1, CHARACTERIZED in that the reflecting prism face extends so that a direction of electric vector's vibration of an s-polarized light component of a reflecting light ray caused by an incident light ray in a predetermined propagation direction is in parallel with a polarization axis of the polarizing plate.

3. A surface illumination device comprising a light guide plate that has a reflecting prism face and a light exit face opposite to the prism face for propagating incident light inside the plate and reflecting the light at the reflecting prism face to output the light from the light exit face,
which further comprises a polarizing plate provided opposite to the light exit face,
the reflecting prism face extending so that a direction of electric vector's vibration of an s-polarized light component of a reflecting light ray caused by an incident light ray in a predetermined propagation direction is in parallel with a polarization axis of the polarizing plate.

4. A surface illumination device as defined in claim 2, CHARACTERIZED in that the illumination device further comprises:
a side light section comprising a light emission section and a light guide body section for propagating the light emitted by the light emission section to widely introduce it into an end face of the light guide plate; and
un-divergence means for reducing a degree of divergence of light incident on an end face of the light guide plate,
the un-divergence means including a prism body section arranged to cause the light to be incident on the light guide plate in such a manner that the incident light ray in the predetermined propagation direction comes into the reflecting prism face.

5. A surface illumination device comprising: a light guide plate that has a reflecting prism face and a light exit face opposite to the prism face for propagating incident light inside the plate and reflecting the light at the reflecting prism face to output the light from the light exit face; and a side light section for introducing the light into an end face of the light guide plate, CHARACTERIZED in that:
the side light section comprises a light emission section and a polarizing section for polarizing the light emitted by the light emission section, and is arranged so that the polarized light component is introduced into an end face of the light guide plate; and
the polarizing section has a polarizing axis parallel with a direction of electric vector's vibration of an s-polarized light component of a reflecting light ray caused in the reflecting prism face by an incident light ray in a predetermined propagation direction.

6. A surface illumination device as defined in claim 5, CHARACTERIZED in that:
the side light section comprises a light guide body section for propagating the light emitted by the light emission section to widely introduce it into an end face of the light guide plate;
the surface illumination device further comprises un-divergence means for causing a degree of divergence of the light incident on an end face of the light guide plate to be reduced; and
the un-divergence means comprise a prism body section arranged to make light to enter the light guide plate in such a manner that the incident light ray in the predetermined propagation direction is introduced into the reflecting prism face.

7. A surface illumination device as defined in any one of claim 2, CHARACTERIZED in that: the predetermined propagation direction is a propagation direction in which the incident light ray can make a plane of incidence that is perpendicular to the reflecting prism face and the light exit face.

8. A surface illumination device as defined in any one of claim 2, CHARACTERIZED in that a plurality of swath-shaped faces are used for the reflective prism face, and the predetermined propagation direction is a direction along a plane perpendicular to a longitudinal direction of the swath-shaped face.

9. A surface illumination device as defined in claim 4, CHARACTERIZED in that the prism body section is formed integral with the light guide plate.

10. A surface illumination device as defined in claim 4, CHARACTERIZED in that the prism body section is formed on the polarizing section.

11. A surface illumination device as defined in claim 4, CHARACTERIZED in that the prism body section is formed integral with the light guide body section.

12. A display device using a surface illumination device as defined in any one of claim 1, CHARACTERIZED in that the surface illumination device is arranged in such a manner that the light exit face is faced to a display face of the display device.

13. A display device as defined in claim 12, CHARACTERIZED in that the display device has a second polarizing plate provided faced to the light exit face, the reflecting prism face extending so that a direction of electric vector vibration of an s-polarized light component of a reflecting light ray caused by an incident light ray in the predetermined propagation direction is also in parallel with a polarization axis of the second polarizing plate.

14. A liquid crystal display device using a surface illumination device as defined in claim 3, CHARACTERIZED in that the display device comprises a liquid crystal cell for performing optical modulation in accordance with an image to be displayed, the polarizing plate being carried on the liquid crystal cell.

15. A surface illumination device comprising: a light guide plate that has a reflecting prism face and a light exit face opposite to the prism face for propagating incident light inside the plate and reflecting the light at the reflecting prism face to output the light from the light exit face; and a side light section for making light to be incident on an end face of the light guide plate, wherein
the side light section comprises a light emission section, a light guide body section for propagating the light emitted by the light emission section to widely introduce it into an end face of the light guide plate, and un-divergence means for causing a degree of divergence of the light incident on an end face of the light guide plate to be reduced,
the un-divergence means comprises a prism body section formed integral with the light guide body section.

16. A surface illumination device as defined in claim 15, CHARACTERIZED in that the light guide body section has a light exit face faced toward an end face of the light guide plate and a light reflective face opposed to the exit face, the prism body section being formed by projections and depressions of the light exit face.
